(19) United States
(12) Patent Application Publication
(10) Pub. No.: US 2026/0290716 A1
(43) Pub. Date: Sep. 24, 2026

(54) KEY STRUCTURE AND ELECTRONIC DEVICE

(71) Applicant: AAC Acoustic Technologies (Shanghai) Co., Ltd., Shanghai (CN)

(72) Inventors: Hongguang Li, Shanghai (CN); Hanliang Shen, Shanghai (CN)

(21) Appl. No.: 19/294,319

(22) Filed: Aug. 8, 2025

Related U.S. Application Data
(63) Continuation of application No. PCT/CN2025/083990, filed on Mar. 21, 2025.

(51) Int. Cl. H01H 3/02; H01H 3/00

(52) U.S. Cl. CPC H01H 3/0253; H01H 2003/007; H01H 2209/052; H01H 2211/024; H01H 2239/052

(57) ABSTRACT

The present disclosure relates to the technical field of keys. A key structure and an electronic device are provided. The key structure includes a key portion, an elastic assembly, a flexible circuit board, at least two pressure sensors, and a supporting assembly. The elastic assembly is attached to a side of the key portion opposite to a pressed side. A side of the elastic assembly away from the key portion is fixedly connected to a housing of the electronic device by a supporting assembly. The elastic assembly has an accommodating cavity, and a supporting section of the flexible printed circuit board and pressure sensors electrically connected with the supporting section are both arranged in the accommodating cavity. The elastic assembly includes two deformation ends arranged oppositely, and at least two pressure sensors are respectively arranged at the two deformation ends.

### CROSS REFERENCE TO RELATED APPLICATIONS

The present application is a continuation of PCT Patent Application No. PCT/CN2025/083990, filed Mar. 21, 2025, which is incorporated by reference herein in its entirety.

### TECHNICAL FIELD

The present disclosure relates to the technical field of keys, and in particular to a key structure and an electronic device.

### BACKGROUND

Pressure sensors in a key structure generally exist in the form of flexible printed circuit (FPC) or printed circuit board (PCB), the pressure sensors are stuck on a surface of the key structure or inside the key structure. By pressing the key structure to touch the pressure sensor, a material of the sensor is deformed, so that the resistance or capacitance of the sensor is changed, to achieve the purpose of pressure detection.

In the related art, a pressure sensor is arranged corresponding to a pressed position of the key structure, and the pressure sensor detects a pressure parameter of the pressed position. Moreover, the pressure sensor can only detect the pressure parameter of the corresponding pressed position, and it is difficult to detect the pressure parameters of other positions of the key structure. That is, the pressure sensor of the key structure is difficult to realize continuous sliding pressure detection. Therefore, the application range of the key structure has great limitations. For example, when the key structure is applied to a side of a mobile phone, it is difficult to adjust the volume, focal length, etc. by sliding the key structure.

Therefore, it is necessary to provide a key structure to solve the above problems.

### SUMMARY

In view of the above problems, an object of the present disclosure is to provide key structure and an electronic device, which can detect pressure parameters of a key structure subjected to continuous sliding and meet the design requirements of adjusting the functions of the electronic device by continuously sliding the key structure.

In a first aspect, a key structure is provided, which includes:
a key portion, having a pressed side;
an elastic assembly, including a first elastic member fixed to a side of the key portion away from the pressed side, a supporting portion fixed to a side of the first elastic member away from the key portion, and a second elastic member fixed to the supporting portion and spaced apart from the first elastic member to form an accommodating cavity, where the second elastic member has a middle portion arranged opposite to and spaced apart from the first elastic member and two deformation ends arranged at two opposite ends of the middle portion, and the two deformation ends are fixedly connected with the supporting portion;
a supporting assembly, connected to a side of the middle portion away from the first elastic member, where the two deformation ends are spaced apart from the supporting assembly, and a side of the supporting assembly away from the middle portion is fixed to a housing of an electronic device;
a flexible circuit board, including a supporting section located in the accommodating cavity and fixed to a side of the second elastic member facing the first elastic member and a bent section formed by bending and extending the supporting section in a direction away from the key portion, where the bent section is electrically connected with an external circuit; and
at least two pressure sensors, fixed to a side of the supporting portion facing the first elastic member, where each respective deformation end of the two deformation ends is correspondingly arranged with at least one pressure sensor along a pressed direction of a pressed side, and the at least two pressure sensors are electrically connected with the supporting section.

As an improvement, two supporting portions are provided, the two supporting portions are respectively arranged at two ends of the first elastic member, and the at least two pressure sensors are arranged between the two supporting portions.

As an improvement, each respective supporting portion of the two supporting portions is fixed at an end of a respective deformation end of the two deformation ends away from the middle portion.

As an improvement, the supporting assembly includes a first supporting member connected to the side of the middle portion away from the first elastic member, and a second supporting member connected to a side of the first supporting member away from the middle portion, where the second supporting member is spaced apart from the two deformation ends along the pressed direction of the pressed side, and a side of the second supporting member away from the first supporting member is fixed to the housing of the electronic device.

As an improvement, two ends of the supporting member are symmetrically arranged with respective to the middle portion, and a length of the second supporting member is greater than or equal to a length of the second elastic member.

As an improvement, a length of the first elastic member is equal to a length of the key portion, and a bottom end of the first elastic member completely covers a side of the key portion opposite to the pressed side.

As an improvement, the bent section is connected to a middle of the supporting section.

In a second aspect, an electronic device is provided, which includes a housing and the above key structure fixed to the housing, where the key portion is exposed from the housing, the elastic assembly, the flexible circuit board, and the at least two pressure sensors are all arranged in the housing, and a side of the elastic assembly away from the key portion is fixedly connected to the housing.

According to the key structure and the electronic device of the embodiment of the present disclosure, when the pressed side of the key portion is subjected to an external pressure, the key portion transmits the external pressure to the supporting portion on the side of the first elastic member away from the key portion by the first elastic member, the supporting portion transmits the pressure to the two deformation ends of the second elastic member, and the two deformation ends are deformed by force to generate strain. The strain of each deformation end is transmitted to the corresponding pressure sensor. The resistance information of the corresponding pressure sensor is transmitted to the external circuit through the supporting section and the bent section in sequence, and the pressed position of the key portion is calculated according to the resistance parameters of the at least two pressure sensors, and then the parameters, such as volume and focal length of the electronic device, are adjusted according to the pressed position of the key portion.

### BRIEF DESCRIPTION OF THE DRAWINGS

In order to explain the technical solution of the present disclosure more clearly, brief description will be given to the accompanying drawings required for the description of the embodiments. Obviously, the drawings in the following description are only some embodiments of the present disclosure, and other drawings can be obtained according to these drawings without creative efforts.

FIG. 1 is an assembly schematic diagram of a key structure according to a first embodiment of the present disclosure.

FIG. 2 is a schematic exploded view of the key structure shown in FIG. 1.

FIG. 3 is a cross-sectional view of a partial structure of the key structure taken along line A-A in the key structure shown in FIG. 1.

### DETAILED DESCRIPTION OF THE EMBODIMENTS

In order to make the purpose, technical solutions and advantages of the present disclosure more clear, various embodiments of the present disclosure will be described in detail with the attached drawings. However, it can be understood by those skilled in the art that in various embodiments of the present disclosure, many technical details are provided for readers to better understand the present disclosure. However, even without these technical details and various changes and modifications based on the following embodiments, the technical solutions claimed by the present disclosure can be realized.

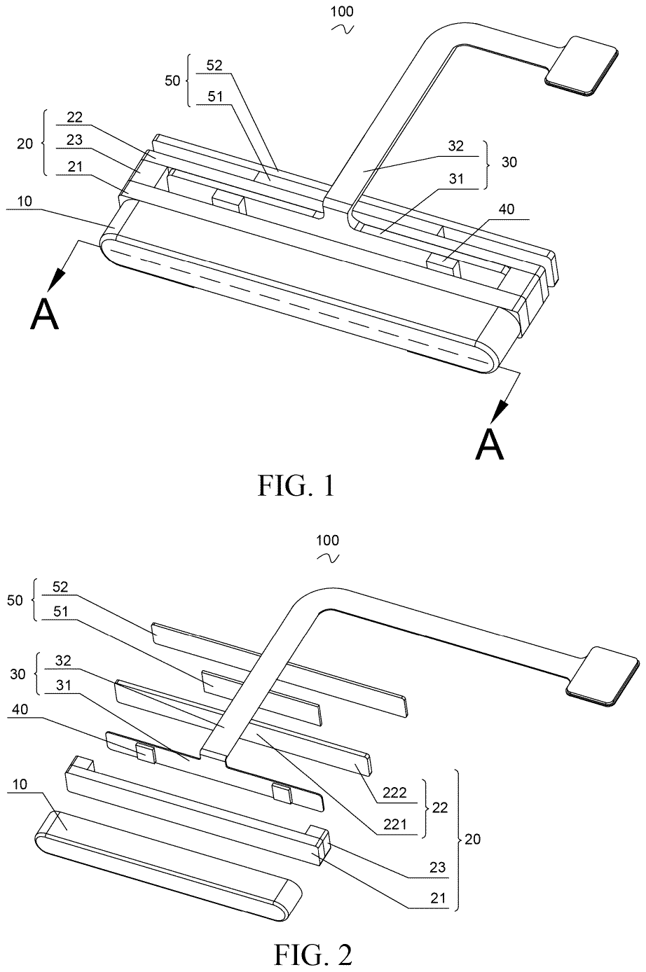

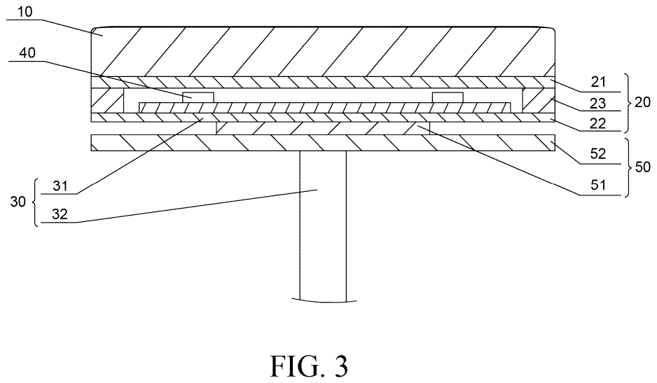

Referring to FIG. 1 to FIG. 3, a key structure 100 is provided according to the technical solutions of the present disclosure, which includes a key portion 10, an elastic assembly 20, a flexible circuit board 30, at least two pressure sensors 40, and a supporting assembly 50. Specifically, the key portion 10 has a pressed side. The elastic assembly 20 is fixed to a side of the key portion 10 opposite to the pressed side of the key portion 10. The supporting assembly 50 is connected to a side of the elastic assembly 20 away from the key portion 10, and a side of the supporting assembly 50 away from the elastic assembly 20 is fixed to a housing of an electronic device (not shown in the figures). The elastic assembly 20 has an accommodating cavity, and a supporting section 31 of the flexible circuit board 30 and the at least two pressure sensors 40 are respectively arranged in the accommodating cavity of the elastic assembly 20. The at least two pressure sensors 40 are fixed to the supporting section 31 and are electrically connected with the supporting section 31. The pressure sensors 40 are configured to collect pressure parameters generated by the supporting section 31 after the key portion 10 is pressed.

Specifically, the elastic assembly 20 includes a first elastic member 21, a second elastic member 22, and a supporting portion 23. The first elastic member 21 is fixed to a side of the key portion 10 away from the pressed side. The supporting portion 23 is fixed to a side of the first elastic member 21 away from the key portion 10. The second elastic member 22 is fixed to a side of the supporting portion 23 away from the first elastic member 21. The second elastic member 22 is spaced apart from the first elastic member 21 to form an accommodating cavity for accommodating the supporting section 31 of the flexible circuit board 30 and the pressure sensors 40. Further, the second elastic member 22 includes a middle portion 221 and deformation ends 222 arranged at two opposite ends of the middle portion 221, and the middle portion 221 is arranged opposite to and spaced apart from the first elastic member 21. Specifically, a side of the middle portion 221 away from the first elastic member 21 is connected with the supporting assembly 50, so as to achieve connection with the housing of the electronic device. The two deformation ends 222 at the two ends of the middle portion 221 are respectively connected to the supporting portions 23, such that the pressure applied to the key portion 10 is transmitted to the supporting portion 23 by the first elastic member 21 and then to the second elastic member 22 by the supporting portion 23.

The supporting assembly 50 is connected to the middle portion 221 of the second elastic member 22, and the deformation ends 222 of the second elastic member 22 are spaced apart from the supporting assembly 50. That is, there is a space between the deformation ends 222 and the supporting assembly 50, so that the second elastic member 22 has sufficient deformation space to ensure that the pressure sensors 40 can obtain accurate strain. The side of the supporting assembly 50 away from the middle portion 221 is fixedly connected to the housing of the electronic device.

The flexible circuit board 30 includes a supporting section 31 and a bent section 32. The supporting section 31 is located in the accommodating cavity of the elastic assembly 20 and is fixed to a side of the second elastic member 22 facing the first elastic member 21. The bent section 32 is formed by bending and extending from a middle of the supporting section 31 in a direction away from the key portion 10. The bent section 32 is electrically connected with an external circuit to transmit information of the flexible circuit board 30 to the external circuit.

The at least two pressure sensors 40 are located in the accommodating cavity of the elastic assembly 20, and are fixed to a side of the supporting section 31 of the flexible circuit board 30 facing the first elastic member 21. Each deformation end 222 is arranged corresponding to at least one pressure sensor 40 along a pressed direction of the pressed side, so that the pressure sensors 40 can obtain the deformation and strain of the deformation ends 222, thereby obtaining information such as the pressed position and pressure of the key portion 10.

In the key structure 100 according to the embodiments of the present disclosure, when the pressed side of the key portion 10 is subjected to an external pressure, the key portion 10 transmits the external pressure to the supporting portion 23 on the side of the first elastic member 21 away from the key portion 10 by the first elastic member 21, and the supporting portion 23 transmits the pressure to the two deformation ends 222 of the second elastic member 22, and the two deformation ends 222 are deformed by force to generate strain. The strain of each deformation end 222 is transmitted to the corresponding pressure sensor 40. The resistance of the corresponding pressure sensor 40 changes. The resistance information of the pressure sensor 40 is transmitted to the external circuit through the supporting section 31 and the bent section 32 in sequence, and the pressed position of the key portion 10 is calculated according to the resistance parameters of the at least two pressure sensors 40, and then the parameters, such as volume and focal length of the electronic device, are adjusted according to the pressed position of the key portion 10.

In some embodiments, two supporting portions 23 are provided, the two supporting portions 23 are respectively arranged at two ends of the first elastic member 21, and the at least two pressure sensors 40 are arranged between the two supporting portions 23, so as to prevent the supporting portions 23 from directly contacting with the pressure sensors 40, and avoid the supporting portions 23 from directly transmitting the pressure to the pressure sensors 40, thereby improving the service life of the pressure sensors 40. In addition, there is a gap between the pressure sensors 40 and the first elastic member 21. When the first elastic member 21 is deformed, the first elastic member 21 and the pressure sensors 40 are always in a non-contact state, so as to prevent the first elastic member 21 from directly contacting the pressure sensors 40 and affecting the accuracy of the pressure sensors 40.

In some embodiments, each supporting portion 23 is fixed at an end of the deformation end 222 away from the middle portion 221. When different positions of the deformation end 222 are subjected to the same pressure, the deformation end 222 generates different deformation amounts. When an end of the deformation end 222 close to the middle portion 221 is subjected to the same pressure, the deformation end 222 has the smallest deformation amount. When the end of the deformation end 222 away from the middle portion 221 is subjected to the same pressure, the deformation end 222 has the largest deformation amount. Therefore, fixing the supporting portion 23 at the end of the deformation end 222 away from the middle portion 221 enables the deformation end 222 to generate a large deformation amount, so as to facilitate the pressure sensor 40 to obtain the strain of the deformation end 222.

In some embodiments, two pressure sensors 40 are provided, and are respectively arranged at the two deformation ends 222 of the second elastic member 22. That is, one pressure sensor 40 is arranged at each of the two deformation ends 222 of the second elastic member 22. When the two deformation ends 222 of the second elastic member 22 are deformed to generate strain, the resistances of the two pressure sensors 40 distributed at the two deformation ends 222 change. According to the resistance changes of the two pressure sensors 40, the detection of the pressed position of the key portion 10 can be realized.

In some embodiments, the two deformation ends 222 are symmetrically arranged with respect to the middle portion 221, and the two pressure sensors 40 are symmetrically arranged at the two deformation ends 222 with respect to the middle portion. When the central position of the pressed side of the key portion 10 is subjected to an external pressure, the deformation amounts of the two deformation ends 222 are the same, and the strains of the two deformation ends 222 detected by the two pressure sensors 40 are the same. When the non-central position of the pressed side of the key portion 10 is subjected to an external pressure, the deformation amounts of the two deformation ends 222 are different, and the strains of the two deformation ends 222 detected by the two pressure sensors 40 are different. The specific pressed position of the key portion 10 is calculated according to the two different strains detected by the two pressure sensors 40. By symmetrically arranging the two deformation ends 222 at the two ends of the middle portion 221 and symmetrically arranging the two pressure sensors 40 at the deformation ends 222 at the two ends of the middle portion 221, the calculation process of the two pressure sensors 40 can be simplified. It should be noted that the central position refers to a central position along a length direction of the key portion 10. Correspondingly, the non-central position refers to other positions except the central position along the length direction of the key portion 10.

In some embodiments, the supporting assembly 50 includes a first supporting member 51, and a side of the first supporting member 51 abuts against the middle of a side of the elastic assembly 20 away from the key portion 10. Specifically, the side of the first supporting member 51 is connected to a side of the second elastic member 22 away from the first elastic member 21, and the other side of the first supporting member 51 is configured to be fixedly connected to the housing of the electronic device. The elastic assembly 20 can be fixed to the housing of the electronic device by the supporting assembly 50.

A length of the first supporting member 51 is less than a length of the elastic assembly 20, that is, two ends of the elastic assembly 20 extend outward from two ends of the first supporting member 51 respectively, so as to reduce the influence of the first supporting member 51 on the deformation amounts of the two deformation ends 222 of the elastic assembly 20. Specifically, the first supporting member 51 has the same length as the middle portion 221, the middle portion 221 is connected to the first supporting member 51, and the two deformation ends 222 of the second elastic member 22 are respectively located at the two ends of the first supporting member 51, so as to prevent the first supporting member 51 from affecting the deformation amounts of the two deformation ends 222.

In some embodiments, the supporting assembly 50 further includes a second supporting member 52. The second supporting member 52 is connected to a side of the first supporting member 51 away from the elastic assembly 20, and a side of the second supporting member 52 away from the first supporting member 51 is fixedly connected to the housing of the electronic device. Two ends of the second supporting member 52 are symmetrically arranged with respect to the middle portion 221, and the second supporting member 52 is spaced apart from the two deformation ends 222 of the second elastic member 22. The length of the first supporting member 51 is smaller than a length of the second supporting member 52. By connecting the second supporting member 52 to the housing of the electronic device, a connection area between the key structure 100 and the housing of the electronic device can be increased, thereby improving the connection reliability between the key structure 100 and the housing of the electronic device. In addition, since the length of the second supporting member 52 is the same as the length of the second elastic member 22, the second supporting member 52 can also protect the elastic assembly 20 from the side of the elastic assembly 20 away from the key portion 10, thereby preventing the components of the electronic device from interfering with the deformation of the elastic assembly 20 and improving the reliability of the strain detected by the key structure 100.

In some embodiments, the flexible circuit board 30 further includes a bent section 32 formed by bending and extending from a middle of the supporting section 31 in a direction away from the key portion 10. The supporting section 31 of the flexible circuit board 30 transmits the strain parameters detected by the pressure sensors 40 to the bent section 32, and the bent section 32 transmits the strain parameters to the electronic device, so as to adjust parameters such as the volume and focal length of the electronic device.

In some embodiments, the first elastic member 21, the second elastic member 22, the supporting portions 23, the first supporting member 51, and the second supporting member 52 are all elastic members that are correspondingly strained and reset after being subjected to a force. The elastic member may be a metallic elastic member or a non-metallic elastic member. Specifically, the metallic elastic member is a metal elastic sheet, and the non-metallic elastic member is a non-metal elastic sheet. The non-metal dome is made of any material selected from silicone, foam, and plastic.

An electronic device is further provided according to the technical solutions of the present disclosure, which includes a housing and the above key structure 100 fixed to the housing. The key portion is exposed from the housing, the elastic assembly 20, the flexible circuit board 30, and the at least two pressure sensors 40 are all arranged in the housing, and a side of the elastic assembly 20 away from the key portion 10 is fixedly connected to the housing.

The electronic device according to the embodiments of the present disclosure includes the housing and the key structure 100 accommodated in the housing. The key portion 10 of the key structure 100 is exposed from the housing to facilitate pressing the key portion 10. The elastic assembly 20, the flexible circuit board 30 and the pressure sensors 40 of the key structure 100 are all arranged in the housing, so that the housing of the electronic device is more aesthetic. In addition, the side of the elastic assembly 20 away from the key portion 10 is fixedly connected to the housing, so that the housing of the electronic device can support the side of the elastic assembly 20 away from the key portion 10. When the pressed side of the key portion 10 is subjected to an external pressure, the key portion 10 transmits the external pressure to the supporting portion 23 on the side of the first elastic member 21 away from the key portion 10 by the first elastic member 21, and the supporting portion 23 transmits the pressure to the two deformation ends 222 of the second elastic member 22, and the two deformation ends 222 are deformed by force to generate strain. The strain of each deformation end 222 is transmitted to the corresponding pressure sensor 40, and the resistance information of the corresponding pressure sensor 40 is transmitted to the external circuit through the supporting section 31 and the bent section 32 in sequence. The pressed position of the key portion 10 is calculated according to the resistance parameters of the at least two pressure sensors 40, and then parameters, such as the volume and focal length of the electronic device, are adjusted according to the pressed position of the key portion 10.

The electronic device according to the embodiments of the present disclosure can be an electronic device such as a mobile phone, a tablet computer, a remote controller, and a vehicle-mounted device. The pressure sensor 40 is any one of a piezoresistive sensor, a piezoelectric sensor, and a piezocapacitive sensor that senses the pressing force by strain.

The electronic device according to the embodiments of the present disclosure includes an external circuit (not shown in the figures) and a control processor (not shown in the figures). The control processor is electrically connected with the external circuit, and the external circuit is electrically connected with the bent section 32 of the flexible circuit board 30. The external circuit acquires the information from the pressure sensors 40 through the flexible circuit board 30 and transmits the information to the control processor. The control processor determines the pressed position of the key portion 10 based on the information of the pressure sensors 40, and the control processor adjusts parameters such as the volume and focal length of the electronic device according to the pressed position of the key portion 10.

It can be understood that the above are the specific embodiments for realizing the present disclosure. However, in practical application, various modifications can be made in form and detail without departing from the spirit and scope of the present disclosure.

What is claimed is:

1. A key structure, comprising:
a key portion, having a pressed side;
an elastic assembly, including a first elastic member fixed to a side of the key portion away from the pressed side, a supporting portion fixed to a side of the first elastic member away from the key portion, and a second elastic member fixed to the supporting portion and spaced apart from the first elastic member to form an accommodating cavity, where the second elastic member has a middle portion arranged opposite to and spaced apart from the first elastic member and two deformation ends arranged at two opposite ends of the middle portion, and the two deformation ends are fixedly connected with the supporting portion;
a supporting assembly, connected to a side of the middle portion away from the first elastic member, wherein the two deformation ends are spaced apart from the supporting assembly, and a side of the supporting assembly away from the middle portion is fixed to a housing of an electronic device;
a flexible circuit board, including a supporting section located in the accommodating cavity and fixed to a side of the second elastic member facing the first elastic member and a bent section formed by bending and extending the supporting section in a direction away from the key portion, wherein the bent section is electrically connected with an external circuit; and
at least two pressure sensors, fixed to a side of the supporting portion facing the first elastic member, wherein each respective deformation end of the two deformation ends is arranged corresponding to at least one pressure sensor along a pressed direction of the pressed side, and the at least two pressure sensors are electrically connected with the supporting section.

2. The key structure according to claim 1, wherein two supporting portions are provided, the two supporting portions are respectively arranged at two ends of the first elastic member, and the at least two pressure sensors are arranged between the two supporting portions.

3. The key structure according to claim 2, wherein each respective supporting portion of the two supporting portions is fixed at an end of a respective deformation end of the two deformation ends away from the middle portion.

4. The key structure according to claim 1, wherein the supporting assembly includes a first supporting member connected to the side of the middle portion away from the first elastic member, and a second supporting member connected to a side of the first supporting member away from the middle portion, wherein the second supporting member is spaced apart from the two deformation ends along the pressed direction of the pressed side, and a side of the second supporting member away from the first supporting member is fixed to the housing of the electronic device.

5. The key structure according to claim 4, wherein two ends of the supporting member are symmetrically arranged with respective to the middle portion, and a length of the second supporting member is greater than or equal to a length of the second elastic member.

6. The key structure according to claim 1, wherein a length of the first elastic member is equal to a length of the key portion, and a bottom end of the first elastic member completely covers a side of the key portion opposite to the pressed side.

7. The key structure according to claim 1, wherein the bent section is connected to a middle of the supporting section.

8. An electronic device, comprising a housing and the key structure according to claim 1 fixed to the housing, wherein the key portion is exposed from the housing, the elastic assembly, the flexible circuit board, and the at least two pressure sensors are all arranged in the housing, and a side of the elastic assembly away from the key portion is fixedly connected to the housing.
